(19) United States
(12) Patent Application Publication
(10) Pub. No.: US 2013/0319381 A1
(43) Pub. Date: Dec. 5, 2013

(54) ENGINE INCLUDING VENTURI IN INTAKE AIR FLOW PATH FOR EXHAUST GAS RECIRCULATION SUPPLY

(71) Applicant: Hector Arvizu Dal Piaz, Oakland Township, MI (US)

(72) Inventor: Hector Arvizu Dal Piaz, Oakland Township, MI (US)

(73) Assignee: GM GLOBAL TECHNOLOGY OPERATIONS LLC, Detroit, MI (US)

(21) Appl. No.: 13/483,517

(22) Filed: May 30, 2012

(51) Int. Cl. F02M 25/07; F02F 1/42

(52) U.S. Cl. 123/568.11; 123/193.5

(57) ABSTRACT

An engine assembly includes an engine block defining a first cylinder bore, a cylinder head coupled to the engine block and defining a first intake port and a first exhaust port in communication with the first cylinder bore, a first intake valve located in the first intake port, a first exhaust valve located in the first exhaust port, a first intake runner and a first exhaust gas recirculation passage. The first intake runner defines an intake air supply passage in communication with the first intake port and includes a first restricted flow region forming a venturi. The first exhaust gas recirculation passage is in communication with the first restricted flow region and provides exhaust gas from the engine assembly to the first intake runner at the first restricted flow region.

### FIELD

The present disclosure relates to engine air intake systems.

### BACKGROUND

This section provides background information related to the present disclosure which is not necessarily prior art.

Internal combustion engines may include exhaust gas recirculation systems to provide exhaust gas to the combustion chambers for a subsequent combustion event. In order to provide exhaust gas flow to the combustion chambers a pressure differential is needed between the exhaust flow path of the engine and the location in the intake system where the exhaust gas is reintroduced.

### SUMMARY

An engine assembly may include an engine block defining a first cylinder bore, a cylinder head coupled to the engine block and defining a first intake port and a first exhaust port in communication with the first cylinder bore, a first intake valve located in the first intake port, a first exhaust valve located in the first exhaust port, a first intake runner and a first exhaust gas recirculation passage. The first intake runner may define an intake air supply passage in communication with the first intake port and may include a first restricted flow region forming a venturi. The first exhaust gas recirculation passage may be in communication with the first restricted flow region and may provide exhaust gas from the engine assembly to the first intake runner at the first restricted flow region.

In one arrangement, the first intake runner may be defined in the cylinder head. In an alternate arrangement, an intake manifold coupled to the cylinder head may define the first intake runner.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a schematic section view of the engine assembly from FIG. 1; and

FIG. 3 is a schematic illustration of an alternate engine assembly according to the present disclosure.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. As used herein, the term “module” refers to an application specific integrated circuit (ASIC), an electronic circuit, and/or a processor (shared, dedicated, or group) and memory that execute one or more software or firmware programs.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

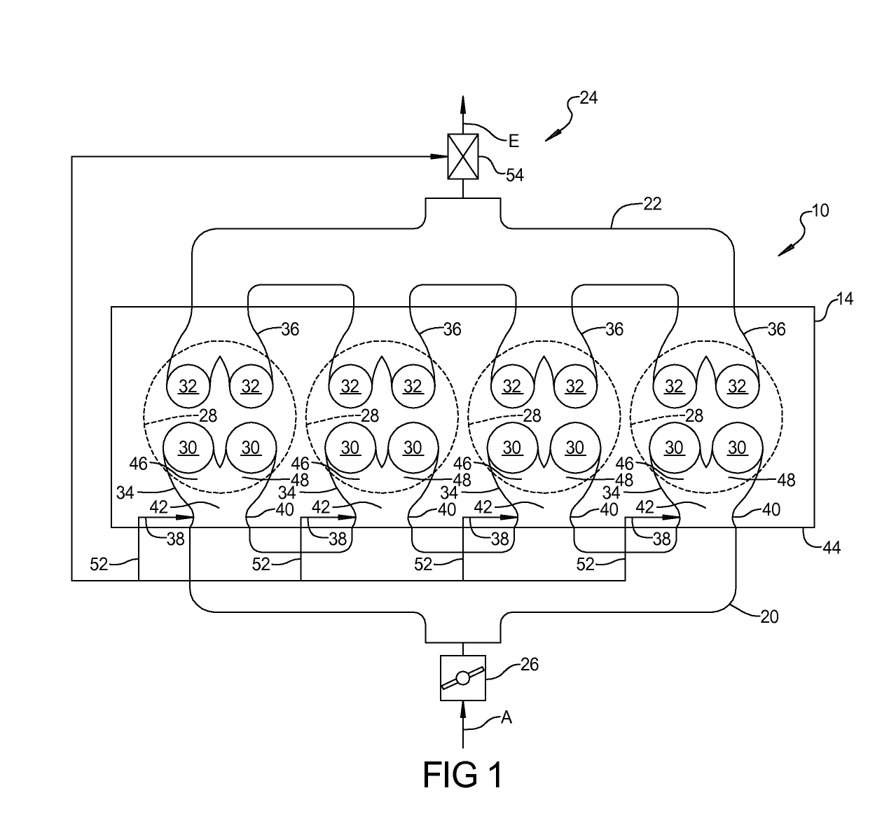

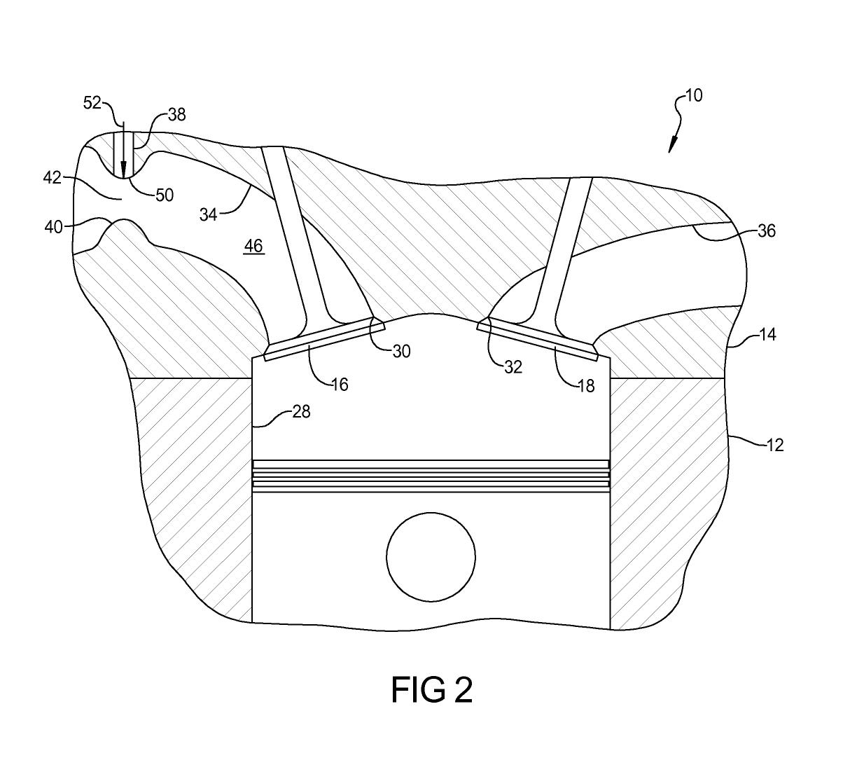

With reference to FIGS. 1 and 2, an engine assembly 10 may include an engine block 12, a cylinder head 14, intake and exhaust valves 16, 18, intake and exhaust manifolds 20, 22 and an exhaust gas recirculation (EGR) assembly 24. In some arrangements, the engine assembly 10 may include a throttle valve 26. However, the present disclosure applies equally to engines without throttle valves as will be discussed below.

The engine block 12 may define cylinder bores 28. While illustrated as an inline four cylinder arrangement, it is understood that the present disclosure is not limited to such arrangements and applies equally to any number of piston-cylinder arrangements and a variety of reciprocating engine configurations including, but not limited to, V-engines, inline engines, and horizontally opposed engines, as well as both overhead cam and cam-in-block configurations. The cylinder head 14 may be coupled to the engine block 12 and may define intake and exhaust ports 30, 32, intake and exhaust runners 34, 36 and EGR ports 38. The intakes valves 16 may be located in the intake ports 30 and the exhaust valves 18 may be located in the exhaust ports 32. The intake and exhaust manifolds 20, 22 may each be coupled to the cylinder head 14 with the intake manifold 20 in communication with the intake ports 30 and the exhaust manifold 22 in communication with the exhaust ports 32. In arrangements including a throttle valve 26, the throttle valve 26 may control air flow (A) to the intake manifold 20.

The intake runners 34 may each define a restricted flow region 40 forming a venturi. The intake runners 34 may be formed with the cylinder head 14 during casting of the cylinder head 14 and the restricted flow region 40 forming the venturi may be integrally formed with the cylinder head 14 during casting. In arrangements including two intake ports 30 per cylinder bore 28 (seen in FIG. 1), the intake runners 34 may include an inlet region 42 extending from an exterior 44 of the cylinder head 14 and defining an air inlet to the cylinder head 14, a first branch 46 extending from an outlet of the inlet region 42 to a first intake port 30 and a second branch 48 extending from the outlet of the inlet region 42 to the second intake port 30.

The restricted flow region 40 forming the venturi may be located in the inlet region 42. The EGR port 38 may additionally be located in the inlet region 42, and more specifically in the restricted flow region 40 forming the venturi. The EGR port 38 may extend through a circumferential wall 50 defining the venturi to provide communication between the intake runner 34 and exhaust gas from the engine.

The EGR assembly 24 may include EGR passages 52 extending from the exhaust gas flow path (E) exiting the exhaust manifold 22 to each of the EGR ports 38 and an EGR valve 54 in communication with the exhaust gas flow path (E) and the EGR passages 52 and controlling communication between the exhaust gas from the exhaust gas flow path (E) and the EGR passages 52. In the present non-limiting example including a four cylinder arrangement, a first EGR passage 52 may extend to a first intake runner 34 in communication with first and second intake ports 30 for the first cylinder bore 28, a second EGR passage 52 may extend to a second intake runner 34 in communication with first and second intake ports 30 for the second cylinder bore 28, a third EGR passage 52 may extend to a third intake runner 34 in communication with first and second intake ports 30 for the third cylinder bore 28, and a fourth EGR passage 52 may extend to a fourth intake runner 34 in communication with first and second intake ports 30 for the fourth cylinder bore 28.

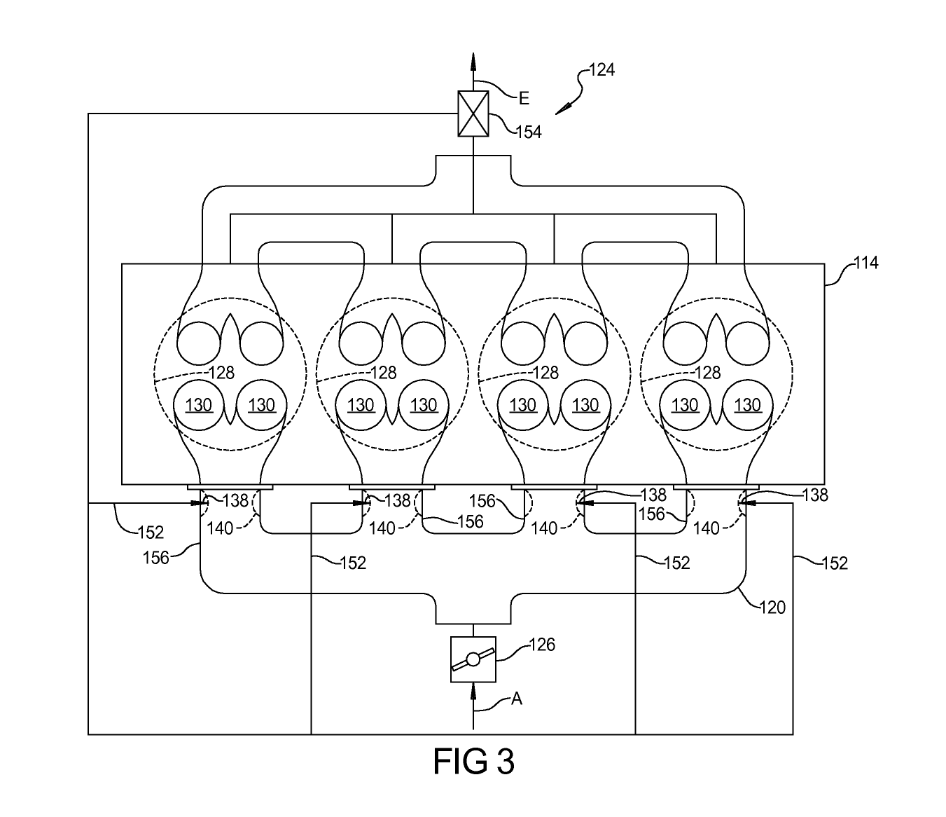

In an alternate arrangement, seen in FIG. 3, the intake manifold 120 may define the restricted flow regions 140 forming the venturis in each of the intake runners 156 (instead of having the venturis located in the cylinder head 114). The intake manifold 120 may include an intake runner 156 for each of the cylinder bores 128. The restricted flow regions 140 in the intake runners 156 in the intake manifold 120 may each define the EGR ports 138.

Similar to the arrangement shown in FIGS. 1 and 2, The EGR assembly 124 may include EGR passages 152 extending from the exhaust gas flow path (E) exiting the exhaust manifold 122 to each of the EGR ports 138 and an EGR valve 154 in communication with the exhaust gas flow path (E) and the EGR passages 152 and controlling communication between the exhaust gas from the exhaust gas flow path (E) and the EGR passages 152. In the present non-limiting example including a four cylinder arrangement, a first EGR passage 152 may extend to a first intake runner 156 in communication with first and second intake ports 130 for the first cylinder bore 128, a second EGR passage 152 may extend to a second intake runner 156 in communication with first and second intake ports 130 for the second cylinder bore 128, a third EGR passage 152 may extend to a third intake runner 156 in communication with first and second intake ports 130 for the third cylinder bore 128, and a fourth EGR passage 152 may extend to a fourth intake runner 156 in communication with first and second intake ports 130 for the fourth cylinder bore 128.

The throttle valve 26, 126 may generally control a pressure drop within the intake manifold 20, 120. During wide open throttle arrangements, and in engines without a throttle valve, the intake manifold 20, 120 may experience little or no pressure drop relative to atmospheric pressure. However, the venturi defined by the restricted flow regions 40, 140 may still provide for exhaust gas flow to the intake ports 30, 130 via the EGR assembly 24, 124. In the arrangements discussed above, the EGR valve 54, 154 could be located before or after a three-way catalyst in the exhaust flow path (E), used in combination with an EGR cooler (not shown) and/or used in combination with a turbocharger (not shown).

What is claimed is:

1. An engine assembly comprising:
an engine block defining a first cylinder bore;
a cylinder head coupled to the engine block and defining a first intake port and a first exhaust port in communication with the first cylinder bore;
a first intake valve located in the first intake port;
a first exhaust valve located in the first exhaust port;
a first intake runner defining an intake air supply passage in communication with the first intake port, the first intake runner including a first restricted flow region forming a venturi; and
a first exhaust gas recirculation passage in communication with the first restricted flow region and providing exhaust gas from the engine assembly to the first intake runner at the first restricted flow region.

2. The engine assembly of claim 1, wherein the first intake runner is defined in the cylinder head.

3. The engine assembly of claim 2, wherein the first restricted flow region forming the venturi is a cast feature formed integrally with the cylinder head.

4. The engine assembly of claim 2, further comprising a second intake valve located in a second intake port defined in the cylinder head and in communication with the first cylinder bore, the first intake runner including an inlet region extending from an exterior of the cylinder head and defining an air inlet to the cylinder head and the first restricted flow region forming the venturi, a first branch extending from an outlet of the inlet region to the first intake port and a second branch extending from the outlet of the inlet region to the second intake port.

5. The engine assembly of claim 2, further comprising a second exhaust gas recirculation passage in communication with the exhaust gas, the engine block defining a second cylinder bore and the cylinder head defining a second intake port in communication with the second cylinder bore and a second intake runner in communication with the second intake port, the second exhaust gas recirculation passage being in communication with the second intake runner and providing the exhaust gas to the second intake runner.

6. The engine assembly of claim 5, wherein the second intake runner includes a second restricted flow region forming a venturi and second exhaust gas recirculation passage is in communication with the second intake runner at the second restricted flow region.

7. The engine assembly of claim 1, further comprising an intake manifold coupled to the cylinder head and defining the first intake runner.

8. The engine assembly of claim 5, wherein the engine block defines a second cylinder bore, the cylinder head defines a second intake port in communication with the second cylinder bore, and the intake manifold defines a second intake runner in communication with the second intake port, the second exhaust gas recirculation passage being in communication with the second intake runner and providing the engine exhaust gas to the second intake runner.

9. The engine assembly of claim 8, wherein the second intake runner includes a second restricted flow region forming a venturi and second exhaust gas recirculation passage is in communication with the second intake runner at the second restricted flow region.

10. The engine assembly of claim 1, further comprising a second intake runner defining an intake air supply passage and a second exhaust gas recirculation passage, the engine block defining a second cylinder bore and the cylinder head defining a second intake port in communication with the second cylinder bore and the second intake runner with the second exhaust gas recirculation passage providing communication between the second intake runner and the exhaust gas.

11. The engine assembly of claim 10, wherein the second intake runner includes a second restricted flow region forming a venturi in communication with the second exhaust gas recirculation passage.

12. The engine assembly of claim 1, further comprising an exhaust gas recirculation valve located in the first exhaust gas recirculation passage and adapted to control communication between the first intake runner and the exhaust gas.

13. The engine assembly of claim 1, wherein the first restricted flow region defines increased velocity region in the first intake runner and the EGR passage is in communication with the increased velocity region to draw the exhaust gas into the first intake runner.

14. The engine assembly of claim 13, further comprising a throttle valve controlling air flow to the first intake runner, the increased velocity region defined by the first restricted flow region adapted to provide exhaust gas flow to the first intake runner while the throttle valve is in a fully open position.

15. The engine assembly of claim 1, wherein the first exhaust gas recirculation passage is in communication with the first exhaust port.

16. A cylinder head for an internal combustion engine comprising:
a first intake port defined in the cylinder head and adapted to provide intake air to a first cylinder bore of the engine;
a first exhaust port defined in the cylinder head and adapted to provide an exhaust gas flow path from the first cylinder bore the first cylinder bore; and
a first intake runner defined in the cylinder head and forming an intake air supply passage in communication with the first intake port, the first intake runner including a first restricted flow region forming a first venturi and a first exhaust gas recirculation port extending through a circumferential wall defining the first venturi and adapted to provide communication between the first intake runner and exhaust gas from the engine.

17. The cylinder head of claim 16, wherein the first restricted flow region forming the venturi is a cast feature formed integrally with the cylinder head.

18. The cylinder head of claim 16, wherein the cylinder head defines a second intake port adapted to provide intake air to the first cylinder bore of the engine, the first intake runner including an inlet region extending from an exterior of the cylinder head and defining an air inlet to the cylinder head and the first restricted flow region forming the venturi, a first branch extending from an outlet of the inlet region to the first intake port and a second branch extending from the outlet of the inlet region to the second intake port

19. The cylinder head of claim 16, wherein the cylinder head defines a second intake port adapted to provide intake air to a first cylinder bore of the engine, a second intake runner forming an intake air supply passage in communication with the second intake port and a second exhaust gas recirculation port in communication with the second intake runner and adapted to provide exhaust gas to the second intake runner.

20. The cylinder head of claim 19, wherein the second intake runner includes a second restricted flow region forming a second venturi and a second exhaust gas recirculation port extending through a circumferential wall defining the second venturi and adapted to provide communication between the second intake runner and exhaust gas from the engine at the second restricted flow region.
